(19) United States
(12) Patent Application Publication
(10) Pub. No.: US 2023/0225545 A1
(43) Pub. Date: Jul. 20, 2023

(54) BEVERAGE MAKER

(71) Applicant: The Steelstone Group LLC, Brooklyn, NY (US)

(72) Inventor: Naphtali H. Biegeleisen, Brooklyn, NY (US)

(21) Appl. No.: 18/099,019

(22) Filed: Jan. 19, 2023

Related U.S. Application Data
(60) Provisional application No. 63/300,873, filed on Jan. 19, 2022.

(51) Int. Cl. A47J 31/40; A47J 31/06; A47J 31/44; A47J 31/24

(52) U.S. Cl. CPC A47J 31/407; A47J 31/0626; A47J 31/4407; A47J 31/24

(57) ABSTRACT

A beverage maker includes a water source; a filter holder; and a beverage cartridge holder. The beverage cartridge holder may be positioned between the water source and the filter holder and configured for fluid communication between the water source and the filter holder.

### CROSS-REFERENCE TO RELATED APPLICATIONS

This application claims the benefit of U.S. Provisional Application No. 63/300,873, filed Jan. 19, 2022, the contents of which are incorporated by reference herein.

### FIELD

The present disclosure relates to a beverage maker. For example, the present disclosure relates to coffee makers.

### BACKGROUND

Various methods for brewing beverages exist. For example, coffee makers known to the inventor(s) take various forms and include percolating coffee makers that generally include a carafe to brew multiple coffee servings at one time. Other coffee makers known to the inventor(s) include single-serving coffee makers that use coffee cartridges to brew coffee.

The description provided in the background section should not be assumed to be prior art merely because it is mentioned in or associated with the background section. The background section may include information that describes one or more aspects of the subject technology.

### SUMMARY

In some embodiments, a beverage maker may include a water source that can be used in two modes of the beverage maker. This may provide a more convenient beverage maker. In some embodiments, a beverage maker may be provided. The beverage maker may include a water source; a filter holder; and a beverage cartridge holder. The beverage cartridge holder may be positioned between the water source and the filter holder and configured for fluid communication between the water source and the filter holder.

In some embodiments, the water source may be configured to capture a beverage cartridge that is placed in the beverage cartridge holder.

In some embodiments, the beverage maker may further include a lid, the water source being positioned at the lid. The lid may include a recess that at least partly accommodates the beverage cartridge that is placed in the beverage cartridge holder.

In some embodiments, the beverage maker may further include a beverage cartridge adapter including the beverage cartridge holder. The beverage cartridge adapter is latched to lid, or wherein the beverage cartridge adapter is latched to the filter holder.

In some embodiments, the beverage maker may further include: one or more latches configured to latch the beverage cartridge adapter to the lid, or to latch the beverage cartridge adapter to the filter holder; and one or more buttons that disengage the one or more latches.

In some embodiments, the beverage maker may further include a housing body. The lid and the beverage cartridge adapter may be configured to be rotated with respect to the housing body.

In some embodiments, the beverage maker may further include a beverage cartridge adapter including the beverage cartridge holder. The beverage cartridge adapter may include a side guide that forms the beverage cartridge holder; and an adapter bottom below the side guide.

In some embodiments, the side guide may extend upward from the adapter bottom, the side guide being provided with one or more side outlets.

In some embodiments, the adapter bottom may form a showerhead style fluid dispenser that is provided with a plurality of outlets for fluid communication between the beverage cartridge holder and the filter holder.

In some embodiments, the adapter bottom may include a first bottom portion and a second bottom portion that is surrounded by the first bottom portion in the plan view. The plurality of outlets may include a plurality of first bottom outlets in the first bottom portion, and a plurality of second bottom outlets in the second bottom portion.

In some embodiments, the filter holder may include a filter holder bottom provided with a bottom outlet.

In some embodiments, the beverage maker may further include a filter basket configured to support a filter. The filter basket may be positioned between the filter holder and the beverage cartridge holder.

### BRIEF DESCRIPTION OF THE DRAWINGS

FIG. 1 shows a perspective view of a beverage maker according to one embodiment.

FIG. 2 shows a cross sectional view of a beverage maker taken along the 2-2 line in FIG. 1.

FIGS. 3A and 3B show perspective views of the beverage maker of FIG. 1 in a first mode according to one embodiment.

FIG. 4 shows a cross sectional view of another example of a beverage maker according to one embodiment.

FIG. 5A shows a perspective view of the beverage maker of FIG. 1 in a second mode according to one embodiment.

FIG. 5B shows a cross sectional view of another example of the beverage maker of FIG. 4 according to one embodiment.

FIG. 5C shows a side view of a beverage maker according to one embodiment.

FIGS. 6A-C show cross sectional views of one example of use of the beverage maker of FIG. 4 according to one embodiment when the beverage maker is in a first mode.

FIGS. 7A-C show cross sectional views of one example of use of the beverage maker of FIG. 4 according to one embodiment when the beverage maker is in a second mode.

FIG. 8 shows a cross sectional view of a beverage maker according to another embodiment.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

An embodiment of the present disclosure may provide a beverage maker to extract the flavor from brewing materials, such as coffee grounds. Although the present disclosure mainly discusses brewing coffee, a system and a method in the present disclosure may be applied not only to brewing coffee but also to brewing beverages other than coffee, such as tea and any other beverage that can be brewed. The term “brewing material” may include, but is not limited to, coffee grounds, tea leaves, cocoa, fruit, grains, herbs, or any other materials used for brewing. Accordingly, while the beverage maker is described in terms of brewing coffee, it is equally applicable to brewing tea, infusing spirits, and the like.

In one example, the present disclosure may provide a beverage maker that may function in first and second modes. In the first mode (e.g., carafe mode) the beverage maker may brew beverages by having water pass through/around a brewing material on a filter. In the second mode (e.g., cartridge mode), the beverage maker may brew beverages through a single-serve beverage cartridge that has a brewing material. The single-serve beverage cartridge may include, for example, K-Cups® and other single-serve cartridge styles. In one example, a single water source may be used in the first and second modes. This may provide a more convenient beverage maker.

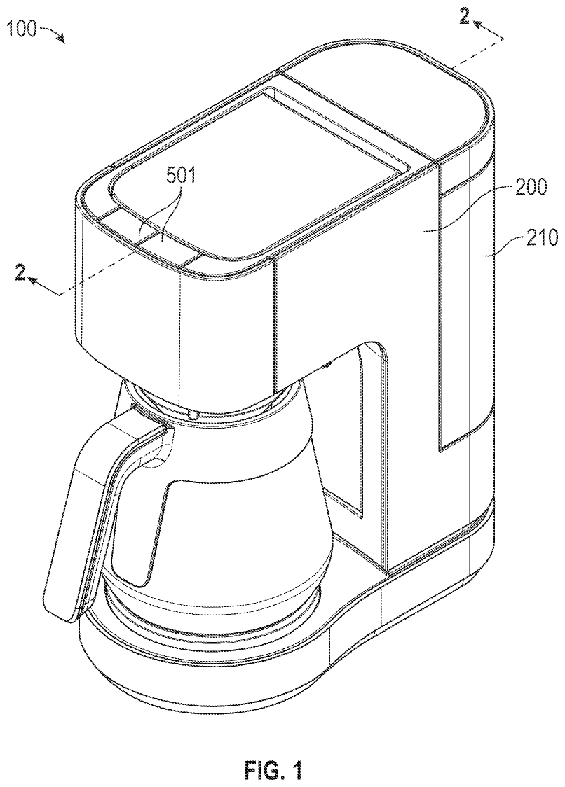

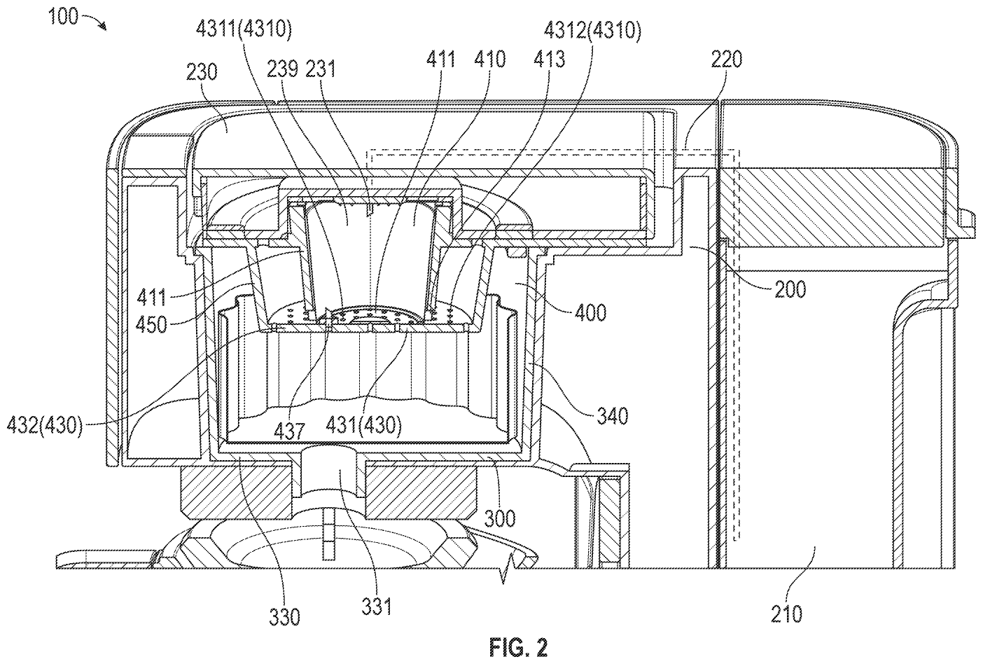

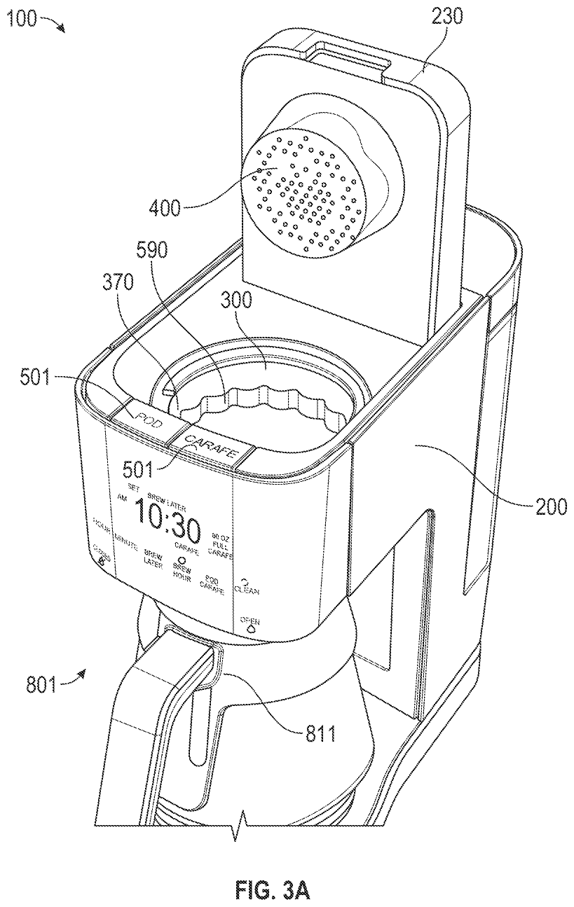

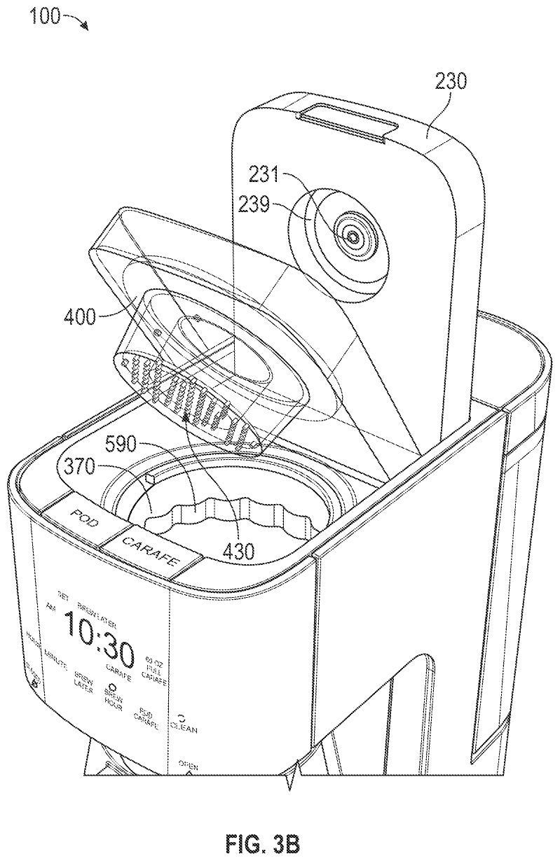

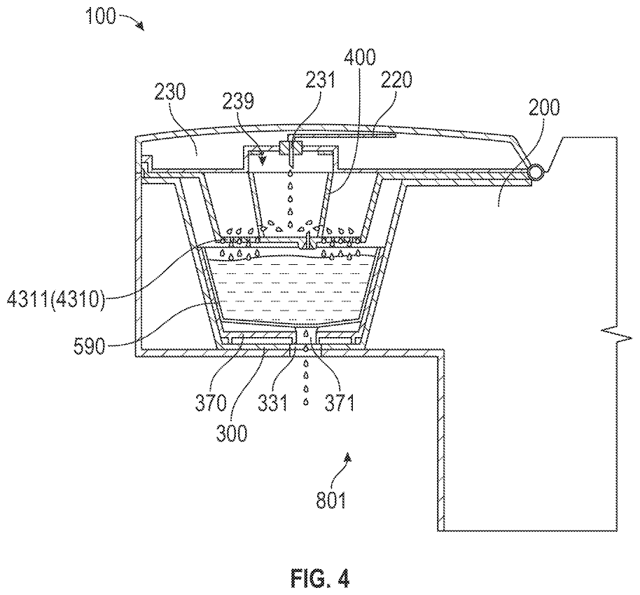

FIG. 1 shows a perspective view of a beverage maker according to one embodiment. FIG. 2 shows a cross sectional view of a beverage maker taken along the 2-2 line in FIG. 1. FIGS. 3A and 3B show perspective views of the beverage maker of FIG. 1 according to one embodiment. FIG. 4 shows a cross sectional view of another example of a beverage maker according to one embodiment. FIGS. 3A, 3B, and 4 show beverage makers in the first mode 801.

As shown in FIGS. 1-3B, the beverage maker 100 may include a housing body 200, a water tank 210, a water path 220, a lid 230, a water source 231, a filter holder 300, and a beverage cartridge adapter 400. The water tank 210 may be fluidly communicated with the water path 220. The lid 230 may be attached to the housing body 200. The lid 230 may include a recess 239 (see FIG. 3B). The water source 231 may be fluidly communicated with the water path 220. In one embodiment, the water source 231 may be positioned at the lid 230. In the example of FIGS. 2 and 3B, the water source 231 may be positioned in the recess 239 of the lid 230. As shown in FIG. 2, the water source 231 may be a needle, but may be any configuration other than a needle. In one embodiment as shown in FIG. 2, the water source 231 may extend vertically, but may extend in a direction different from the vertical direction. Typically, such a vertically extending needle may be usable to pierce a lid of a single-serve beverage cartridge during use. In the illustrated example, the water source 231 may include a liquid path along the longitudinal direction of the water source 231.

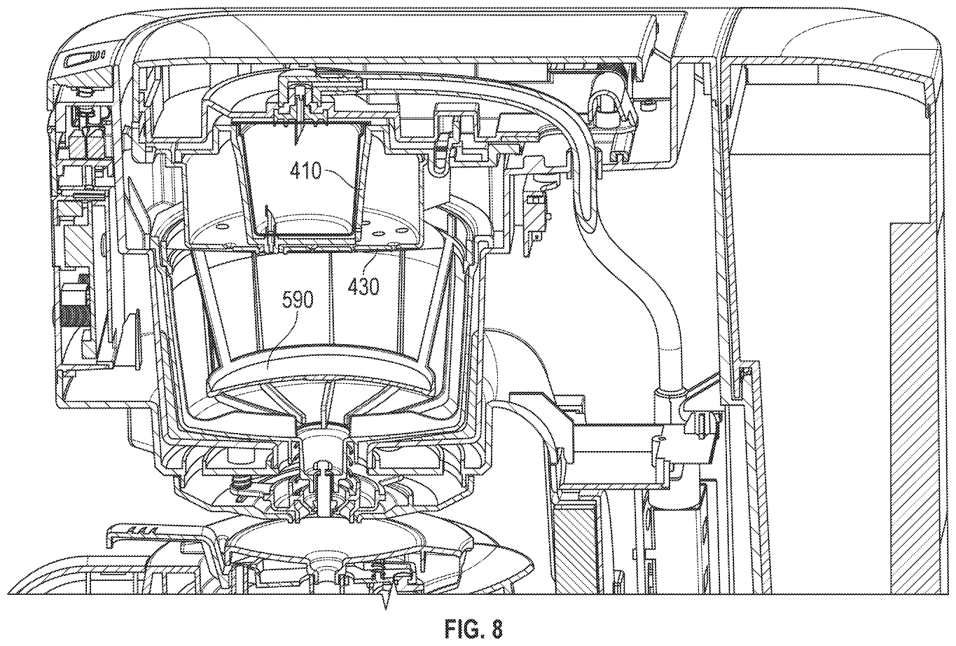

As shown in FIGS. 2 and 3A, the filter holder 300 may be positioned in the housing body 200. The filter holder 300 may hold a filter 590, on or in which brewing material such as coffee grounds is held. The filter 590 may be a disposable paper filter. In some example, as shown in FIG. 8, the filter 590 may be a reusable filter that includes, for example, a metal mesh or a cloth. The filter holder 300 may include a filter holder bottom 330 and a filter holder side 340. The filter holder bottom 330 may be provided with a bottom outlet 331. The filter holder side 340 may extend upward from the filter holder bottom 330. As shown in FIGS. 3A and 4, optionally, a filter basket 370 may be disposed in the filter holder 300. The filter basket 370 may be configured to support the filter 590. In one embodiment shown in FIG. 4, the filter basket 370 may be provided with an outlet 371 that overlaps with the outlet 331 of the filter holder 300.

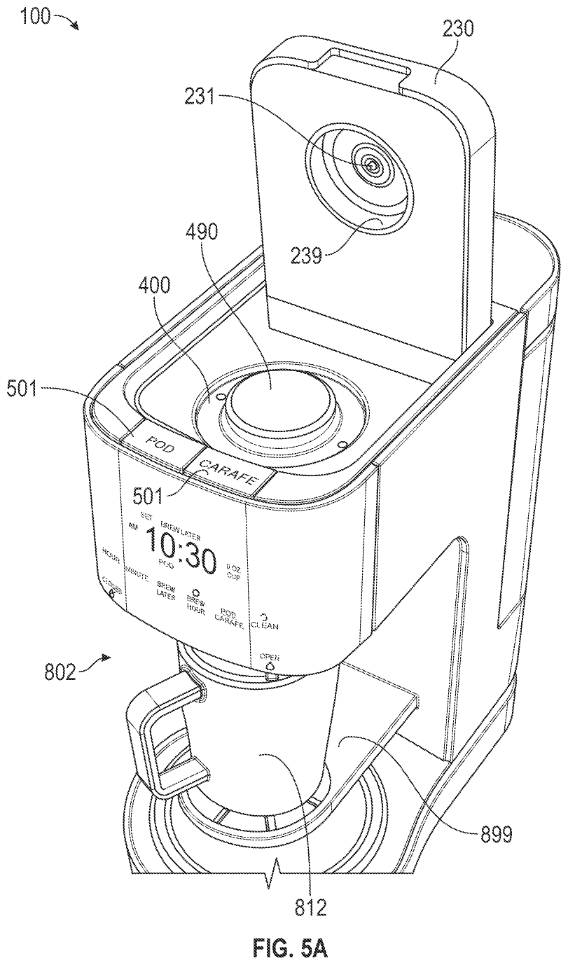

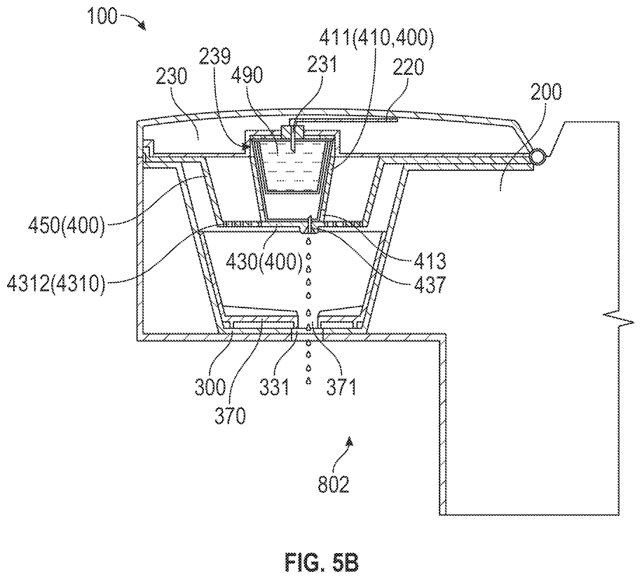

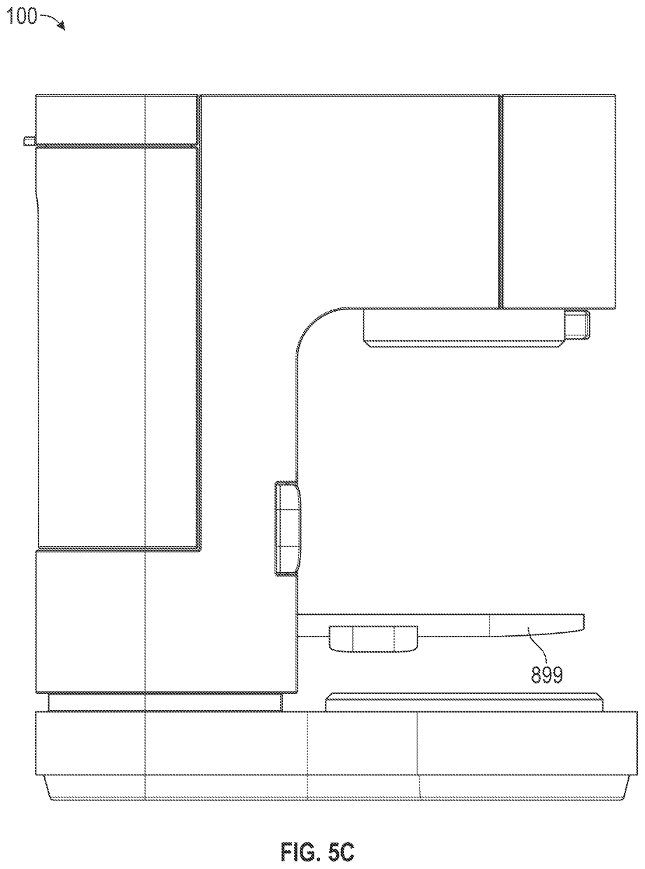

FIG. 5A shows a perspective view of the beverage maker of FIG. 1 according to one embodiment. FIG. 5B shows a cross sectional view of another example of the beverage maker of FIG. 4 according to one embodiment. FIG. 5C shows a side view of a beverage maker according to one embodiment. FIGS. 5A, 5B, and 5C show the beverage makers in the second mode 802.

With reference to FIGS. 2 and 5A-B, the beverage cartridge adapter 400 may be positioned between the filter holder 300 and the water source 231. The beverage cartridge adapter 400 may include a beverage cartridge holder 410, an adapter bottom 430, and an outer side 450. The beverage cartridge holder 410 may be positioned between the water source 231 and the filter holder 300 and may be configured for fluid communication between the water source 231 and the filter holder 300. As shown in FIG. 5B, between the beverage cartridge holder 410 and the filter holder 300, the filter basket 370 may be positioned. In the beverage cartridge holder 410, a beverage cartridge 490 may be placed. In some embodiments shown in FIGS. 5A-B, the beverage cartridge 490 that is placed in the beverage cartridge holder 410 may be pierced by and located relative to the water source 231 (e.g., a needle in one example). The beverage cartridge 490 that is placed in the beverage cartridge holder 410 may be at least partly accommodated by the recess 239 of the lid 230. The beverage cartridge holder 410 may include a side guide 411, below which the adapter bottom 430 is positioned. The side guide 411 may extend upward from the adapter bottom 430. The side guide 411 may be provided with one or more side outlets 413.

In some embodiments, as shown in FIGS. 5A and 5C, in the second mode 802, a platform 899 may be placed below the filter holder 300 to hold a container 812, such as a coffee mug above a bottom plate. In other embodiments, the beverage maker does not include a platform, and the container 812 may be placed directly on the bottom plate. In any event, as shown, in the second mode 802, because the mode is used with single-serve cartridges, the carafe 811 used in the first mode 801 may be replaced with the mug, or other container 812, used in the second mode.

In some embodiments, as shown in FIGS. 2 and 3B, the adapter bottom 430 may form a showerhead style fluid dispenser. In some embodiments, the adapter bottom 430 may be integrally formed with the beverage cartridge holder 410. In other embodiments, as shown in FIG. 8, the adapter bottom 430 may not be integrally formed with the beverage holder 410, and the adapter bottom 430 and the beverage holder 410 may be different components. In some embodiments, the adapter bottom 430 includes a first bottom portion 431 and a second bottom portion 432 that is surrounded by the first bottom portion 431 in the plan view. In the illustrated example, the first and second bottom portions 431 and 432 are different portions of the single adapter bottom 430 (e.g., a single circular plate) that may form a showerhead style fluid dispenser. The first bottom portion 431 may be a portion that is located within the beverage cartridge holder 410, and the second bottom portion 432 may be a portion that is located outside the beverage cartridge holder 410. In one example, the first bottom portion 431 may be circular, and the second bottom portion 432 may be ring-shaped. The shapes of the first bottom portion 431 and the second bottom portion 432 are not limited to these examples, and may be other shapes.

The showerhead style fluid dispenser formed by the adapter bottom 430 may be provided with a plurality of outlets 4310 that are for fluid communication between the beverage cartridge holder 410 and the filter holder 300. This fluid communication may be realized via the side outlets 413 of the side guide 411. The plurality of outlets 4310 may include a plurality of first bottom outlets 4311 in the first bottom portion 431, and a plurality of second bottom outlets 4312 in the second bottom portion 432. In one example, the plurality of outlets 4310 may include only the first bottom outlets 4311 In another example as shown in FIG. 5B, the plurality of outlets 4310 may include only the second bottom outlets 4312. As shown in FIGS. 2 and 5B, in some embodiments, there may be a bottom needle 437 piercing through the adapter bottom 430. The bottom needle 437 may include a liquid path along the longitudinal direction of the bottom needle 437. The outer side 450 may extend upward from the adapter bottom 430. As in the case of the water source 231 when it takes the form of a needle, the bottom needle 437 may be used to pierce a bottom of a single-serve beverage cartridge 490 when in the second mode 802.

Returning to FIG. 3A, the beverage cartridge adapter 400 may be latched to the lid 230. In one embodiment, the lid 230 and the beverage cartridge adapter 400 may be configured to be rotated together with respect to the housing body 200. The beverage maker 100 may include a latch configured to latch the beverage cartridge adapter 400 to the lid 230. With reference to FIG. 5A, the beverage cartridge adapter 400 may be latched to the filter holder 300. In one embodiment, the lid 230 may be configured to be rotated with respect to the beverage cartridge adapter 400 and the housing body 200. The beverage maker 100 may be configured to latch the beverage cartridge adapter 400 to the lid 230, and/or be configured to latch the beverage cartridge adapter 400 to the filter holder 300. The beverage maker 100 may further include one or more buttons 501 (see FIGS. 1, 3A, and 5A) that may disengage the latches. In some embodiments, one of the buttons 501 may disengage one of the latches to expose the filter holder 300 for the first mode 801 (e.g., carafe mode). In some embodiments, the other of the buttons 501 may disengage the other of the latches to expose the top of the beverage cartridge adapter 400 for the second mode 802 (e.g., cartridge mode).

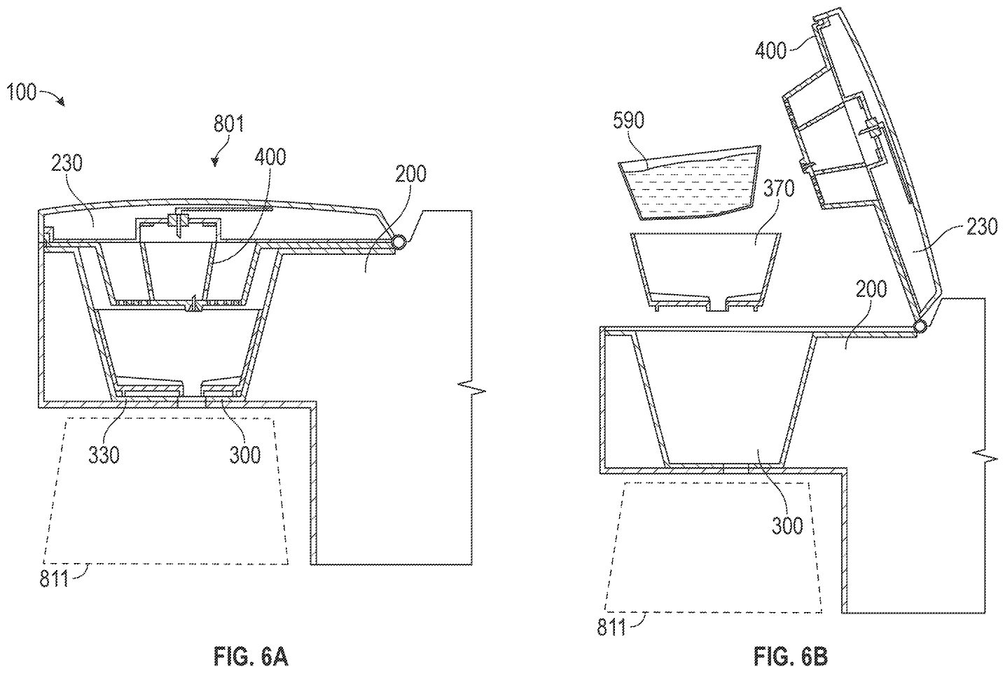

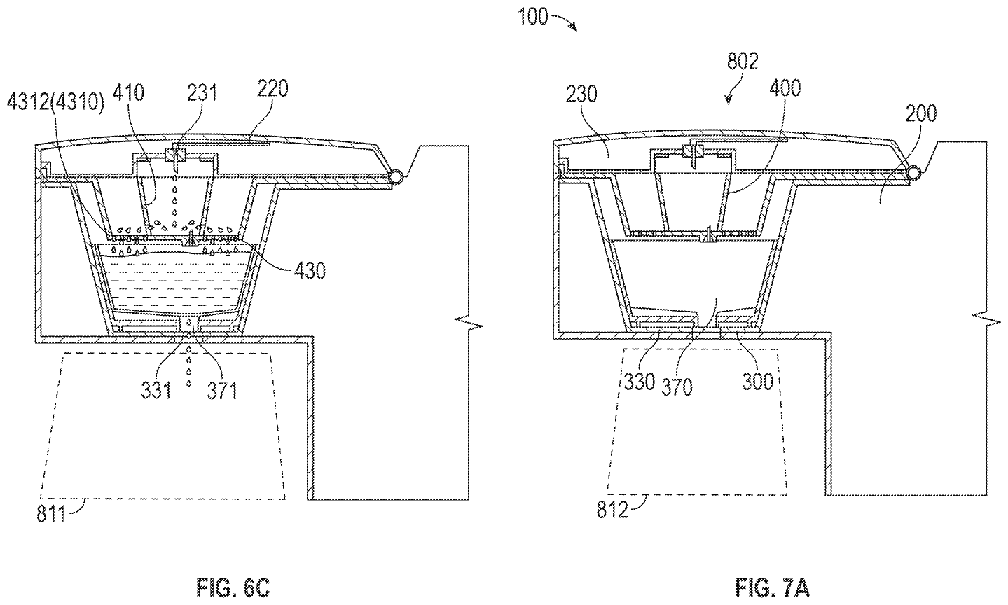

FIGS. 6A-C show cross sectional views of one example of use of the beverage maker of FIG. 4 according to one embodiment when the beverage maker is in the first mode 801.

With reference to FIGS. 6A-6B, when the beverage maker 100 is in the first mode 801 (e.g., carafe mode), a container 811 (see also FIG. 3A) may be placed below the filter holder bottom 330 of the filter holder 300. The container 811 may be a carafe, but may be any other container that can store liquids. In some embodiments, when the beverage maker 100 is in the first mode 801, the user may push one of the buttons 501 (see FIG. 1) that disengages one of the latches, such that the filter holder 300 can be exposed. When the beverage maker 100 is in the first mode 801, the beverage cartridge adapter 400 and the lid 230 are attached to each other, and are configured to be rotated together with respect to the housing body 200 to open the beverage maker 100. Then, as shown in FIG. 6B, the beverage material may be placed on the filter 590, and the filter 590 may be placed within the filter basket 370. Then, the filter basket 370 that holds the filter 590 may be placed in the filter holder 300. Then, as shown in FIG. 6C, after the beverage maker 100 is closed, heated water pumped from the water tank 210 via the water path 220 may be poured via the water source 231 to the beverage cartridge holder 410. Then, the heated water in the beverage cartridge holder 410 may be poured to the beverage material via the outlets 4310 of the adapter bottom 430 and then beverage may be brewed. As such, the adapter bottom 430 with the outlets 4310 functions as a showerhead style fluid dispenser. Then, brewed beverage may be poured into the container 811 via the outlets 331 and 371.

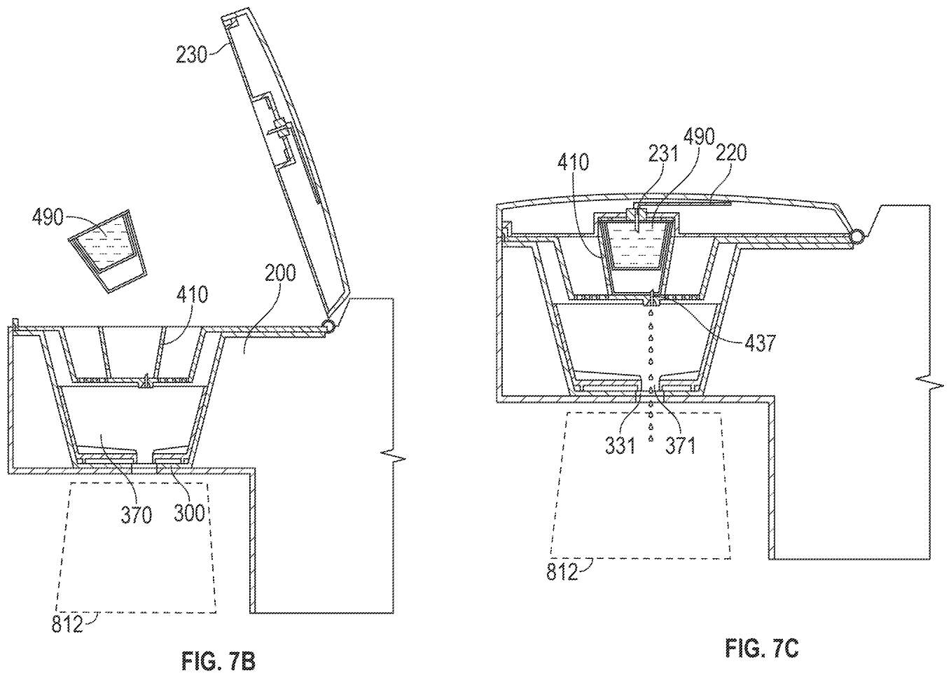

FIGS. 7A-C show cross sectional views of one example of use of the beverage maker of FIG. 4 according to one embodiment when the beverage maker is in the second mode 802.

With reference to FIGS. 7A-7B, when the beverage maker 100 is in the second mode 802 (e.g., cartridge mode), the container 812 (see also FIG. 5A) may be placed on the platform 899 below the filter holder bottom 330 of the filter holder 300. The container 812 may be a cup or mug, but may be any other container that can store liquids. In some embodiments, when the beverage maker 100 is in the second mode 802, the user may push the other one of the buttons 501 (see FIG. 1) that disengages the latch, such that the top of the beverage cartridge adapter 400 can be exposed. Then, as shown in FIG. 7B, the lid 230 is rotated with respect to the housing body 200 to open the beverage maker 100. The beverage cartridge adapter 400 is kept placed on the filter holder 300. Then, the beverage cartridge 490 that contains beverage material may be placed in the beverage cartridge holder 410 of the beverage cartridge adapter 400. Then, as shown in FIG. 7C, after the beverage maker 100 is closed, the water source 231 (e.g., a needle in one example) may pierce through the top of the beverage cartridge 490 placed in the beverage cartridge holder 410 and the bottom needle 437 may pierce through the bottom of the beverage cartridge 490. Then, heated water pumped from the water tank 210 via the water path 220 may be poured via the water source 231 to the beverage material in the beverage cartridge 490 and beverage may be brewed. Then, brewed beverage may be poured into the container 812 via the bottom needle 437 and the outlets 331 and 371.

In one embodiment of the present disclosure, the beverage cartridge holder 410 may be positioned between the water source 231 and the filter holder 300 and may be configured for fluid communication between the water source 231 and the filter holder 300. Therefore, the common water source 231 may be used both in the first mode 801, where beverage material is placed on the filter 590 in the filter holder 300, and in the second mode 802, where the beverage cartridge 490 is placed in the beverage cartridge holder 410. This may provide a more convenient beverage maker.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. A beverage maker, comprising:
a water source;
a filter holder; and
a beverage cartridge holder positioned between the water source and the filter holder and configured for fluid communication between the water source and the filter holder.

2. The beverage maker of claim 1, wherein the water source is configured to capture a beverage cartridge that is placed in the beverage cartridge holder.

3. The beverage maker of claim 2, further comprising a lid, the water source being positioned at the lid,
wherein the lid includes a recess that at least partly accommodates the beverage cartridge that is placed in the beverage cartridge holder.

4. The beverage maker of claim 3, further comprising a beverage cartridge adapter including the beverage cartridge holder,
wherein the beverage cartridge adapter is latched to lid, or wherein the beverage cartridge adapter is latched to the filter holder.

5. The beverage maker of claim 4, further comprising:
one or more latches configured to latch the beverage cartridge adapter to the lid, or to latch the beverage cartridge adapter to the filter holder; and
one or more buttons that disengage the one or more latches.

6. The beverage maker of claim 4, further comprising a housing body,
wherein the lid and the beverage cartridge adapter are configured to be rotated with respect to the housing body.

7. The beverage maker of claim 1, further comprising a beverage cartridge adapter including the beverage cartridge holder,
wherein the beverage cartridge adapter includes a side guide that forms the beverage cartridge holder; and an adapter bottom below the side guide.

8. The beverage maker of claim 7, wherein the side guide extends upward from the adapter bottom, the side guide being provided with one or more side outlets.

9. The beverage maker of claim 7, wherein the adapter bottom forms a showerhead style fluid dispenser that is provided with a plurality of outlets for fluid communication between the beverage cartridge holder and the filter holder.

10. The beverage maker of claim 9, wherein the adapter bottom includes a first bottom portion and a second bottom portion that is surrounded by the first bottom portion in the plan view,
wherein the plurality of outlets include a plurality of first bottom outlets in the first bottom portion, and a plurality of second bottom outlets in the second bottom portion.

11. The beverage maker of claim 1, wherein the filter holder includes a filter holder bottom provided with a bottom outlet.

12. The beverage maker of claim 11, further comprising a filter basket configured to support a filter,
wherein the filter basket is positioned between the filter holder and the beverage cartridge holder.
